(19) United States
(12) Patent Application Publication
(10) Pub. No.: US 2005/0192881 A1
(43) Pub. Date: Sep. 1, 2005

(54) Computer-based transaction system and computer implemented method for transacting services between a service provider and a client

(76) Inventor: John Derek Scannell, Stamford, CT (US)

Correspondence Address: Michael BednareK;SHAW PITTMAN LLP, 1650 TYSONS BOULEVARD, MCLEAN, VA, 22102, US

(21) Appl. No.: 11/048,764

(22) Filed: Feb. 3, 2005

Related U.S. Application Data
(60) Provisional application No. 60/541,036, filed on Feb. 3, 2004.

(51) Int. Cl. G06F 17/60

(52) U.S. Cl. 705/35

(57) ABSTRACT

A computer-based transaction system operated by a service provider includes a stored set of business rules for defining a treaty, a stored set of treaty clauses, and a stored set of service-specific rules. The transaction system is configured to receive and store business-initiating data from a client via a telecommunications network. The transaction system generates automatically a treaty document by applying the business rules to the business-initiating data to select the treaty clauses forming the treaty document. Furthermore, the transaction system selects automatically service-specific rules related to the treaty clauses forming the treaty document. A message management module is configured to map automatically electronic messages received from the client into a data format, defined by the service provider, based on metadata, defined by the selected service-specific rules.

This application claims the benefit of U.S. Provisional Application No. 60/541,036, filed Feb. 3, 2004, which is herein incorporated by reference in its entirety.

### BACKGROUND

1. Field of the Invention

The present invention relates to a computer-based transaction system and a computer-implemented method for transacting services between a service provider and a client. Specifically, the present invention relates to a computer-based transaction system operated by a service provider, a computer implemented method for transacting services between the service provider and a client, as well as a computer program product for controlling one or more processors of the transaction system such that the transaction system executes the transaction method. More specifically, the transaction system, the transaction method, and the computer program product are related to transacting services between the service provider and a plurality of different clients according to different treaty agreements between the service provider and the different clients. Particularly, the transaction system, the transaction method, and the computer program product are related to financial, operational and risk management practices in the reinsurance industry, and more particularly, to managing reinsurance transactions, including processes and transactions involving the generation of quotes and contractual commitments, risk underwriting and administration, claim management and payment and financial and actuarial management and analysis.

2. Background of the Invention

Successful reinsurers depend heavily on the ability to efficiently, accurately, and thoroughly process information. On a daily basis, reinsurers receive an overwhelming amount of business data. Much of this information has immediate ramifications for one or more of the reinsurer's various business functions, such as contract generation, risk underwriting, treaty administration, claims management, technical and financial accounting, and risk identification and management. Reinsurers receive this data in any number of formats, including paper correspondence, intracompany electronic data transmission, and intercompany electronic data transmissions. Particularly, the format and structure of the intercompany electronic data transmission may vary depending on the client concerned. The importance and volume of this data and the various formats in which it is received challenge the reinsurer's ability to marshal the data, translate it into formats compatible with its business processes, and ultimately employ the data to improve business functions and increase profitability.

As an example, reinsurance claims payment and management processes involve receipt of large volumes of data in many different formats. Reinsurers receive claims from insurers seeking payment for coverage under treaty or facultative reinsurance agreements. To ensure proper payment, the reinsurer matches the claim to its corresponding reinsurance agreement and determines whether the circumstances of the claim bring it within the scope of the agreement. Ideally, the reinsurer makes this evaluation for every claim submitted. Often, however, reinsurers are prevented from independently evaluating each claim, given the volume of claims, the different formats in which claim information is received, and the complexity of the treaty terms to which the claims must be compared. Moreover, for new treaty agreements in which new treaty clauses may be introduced to the transaction system and method, service modules of the system need to be maintained and updated constantly, to operate consistently and correctly with regards to treaty agreements having new treaty clauses.

### BRIEF SUMMARY OF THE INVENTION

An aspect of the present invention provides a computer-based transaction system, a computer implemented method, and a computer program product for transacting services between a service provider and a client. In particular, an aspect of the present invention provides a computer-based transaction system, a computer implemented transaction method, and a computer program product enabling the transaction of services between the service provider and a plurality of different clients having different treaty agreements with the service provider and using different formats and structures of the intercompany electronic data transmission. Furthermore, an aspect of the present invention provides a computer-based transaction system, a computer implemented transaction method, and a computer program product that make it possible to add dynamically new treaty clauses without the need to constantly maintain and update programmed service modules transacting business in accordance with the new treaty clauses.

According to an embodiment of the present invention, a computer-based transaction system is operated by the service provider, and includes a stored set of business rules for defining a treaty, a stored set of treaty clauses, a stored set of service-specific rules, means for receiving business-initiating data via a telecommunications network from a client, means for generating a treaty document by applying the business rules to the business-initiating data to select the treaty clauses forming the treaty document, means for selecting automatically from the service-specific rules selected service-specific rules related to the treaty clauses forming the treaty document, and at least one service module configured to transact services between the service provider and the client using the selected service-specific rules.

Generating a treaty document, in that the treaty clauses forming the treaty document are selected by applying the stored business rules to the business-initiating data received from the client, has the advantage that business-initiating data having different formats and structures can be received and processed because the business rules can be defined in view of different formats and structures of intercompany electronic data transmission. Moreover, treaty documents can be generated automatically and flexibly without having to modify (re-program) the module generating the treaty document. The module generating the treaty document remains unchanged, even if treaty clauses are modified and/or business rules are altered.

Furthermore, by selecting service-specific rules related to the selected treaty clauses forming the treaty document, it is possible to adapt dynamically and flexibly any service module to treaty documents generated for different clients. There is no need to configure (program) statically the service modules for defined service-specific rules and/or treaty clauses. There is also no need to modify (re-program) the service modules for new service-specific rules and/or new treaty clauses added dynamically to the system.

Thus, the inventive system makes possible at least two levels of flexibility: (1) automatic and dynamic selection of treaty clauses based on business rules and client data, and (2) automatic and dynamic selection of service-specific rules, based on the selected treaty clauses, for service modules performing downstream processes. Consequently, the inventive system does not only enable flexible generation of treaty documents but also enables dynamic adaptation of “downstream” service modules of the transaction system, transacting services between the service provider and the client in accordance with the clauses included in the treaty document. This means that the service modules apply the selected service-specific rules and thus process and analyze data received from a client in accordance with the treaty document negotiated between the service provider and the respective client. This approach is applied to service modules performing business-oriented transactions such as claims processing or reinsurance administration as well as to service modules performing purely technical transactions such as electronic message transfer. Consequently, format and structure of electronic data communication between client and service provider are determined automatically by the transaction system from treaty terms negotiated between client and service provider.

In one embodiment, the service-specific rules define metadata for an electronic message transfer from the client to the service provider, and the service module is configured to process electronic messages received from the client using the metadata defined by the selected service-specific rules. Particularly, the service module is configured to map automatically electronic messages received from the client into a data format, defined by the service provider, based on metadata, defined by the selected service-specific rules. In other words, the electronic message transfer from the client to the service provider is processed automatically in accordance with the treaty document negotiated between service provider and a particular client. Particularly, based on the selected treaty clauses, the electronic message transfer from the client to the service provider is mapped automatically onto a data format used by the service provider. Consequently, different structures and formats of intercompany data exchange can be supported without having to adapt (program) the service module for electronic messaging for each possible permutation of client, message type, and treaty.

In an embodiment, the service-specific rules include rules of engagement between the client and the service provider, and the service module is configured to check that electronic messages are received from the client at times and frequencies defined by the rules of engagement included in the selected service-specific rules. In other words, the rules of engagement between the client and the service provider are determined by the treaty document negotiated between the service provider and the client. Particularly, based on the selected treaty clauses, it is verified automatically that electronic messages are received from the client at specific reception times and frequencies. Consequently, based on the negotiated treaty, different times and frequencies for submission of specific data from a client to the service provider can be enforced automatically.

In one embodiment, the system includes different service modules configured to transact different services between the service provider and the client, or to support transacting these services. The means for selecting the service-specific rules are configured to select different sets of selected service-specific rules for the different service modules and the system further comprises means to apply the different sets of selected service-specific rules to the respective service modules.

In a further embodiment, the means for selecting the service-specific rules are configured to store the selected service-specific rules assigned to the treaty document and/or to the client. Furthermore, the service module is configured to transact services between the service provider and the client using the selected service-specific rules assigned to the treaty document and/or to the client. For example, the service module is configured to associate an electronic message received from the client with the treaty document and/or with the client, and the service module is configured to process the electronic message using the selected service-specific rules assigned to the treaty document and/or the client associated with the electronic message.

In yet a further embodiment, the treaty document includes performance measures. Furthermore, the system comprises means for determining performance and profitability of services governed by the treaty document by assessing service-specific data related to the services governed by the treaty document against the performance measures.

In a particular embodiment, the business-initiating data relates to a tender from the client to the service provider for reinsurance. The system further comprises a stored set of business rules defining data requirements and the system further comprises means for checking and ensuring completeness of the business-initiating data based on the data requirements, before generating automatically a quote for the tender. The system further comprises means for receiving from the client an acceptance of the quote and the means for generating the treaty document are configured to generate the treaty document in response to the acceptance of the quote. The treaty document includes contractual clauses of a reinsurance agreement. The system further comprises means for receiving from the client an acceptance of the treaty document and the means for selecting the service-specific rules are configured to select the service-specific rules in response to the acceptance of the treaty document. The services transacted by the service module between the service provider and the client include reinsurance services.

In addition to a computer-based transaction system and a computer-implemented method for transacting services between a service provider and a client, an aspect of the present invention also relates to a computer program product including computer program code means for controlling one or more processors of the computer-based transaction system such that the computer-based transaction system transacts services between the service provider and the client, particularly, a computer program product including a computer readable medium containing therein the computer program code means.

As outlined above, a particular embodiment provides a system and method for managing reinsurance transactions. Reinsurance transactions involve interactions among various internal and external reinsurance systems, processes, or parties that result in internal operational/analytical or external corporate actions. Reinsurance transactions involve, for example, elements of data receipt, validation, aggregation, production or exchange, document production, delivery or archival, risk control, or management interactions. Reinsurance transactions can involve objectives as diverse as the issuance of reinsurance quotes or bids, receipt of premiums, payment of claims, financial accounting, performance of risk or contract analyses, audit of compliance with internal or client management/risk controls, deposit of risk or management information in data archives, or the aggregation of this information to promote effective risk management by the reinsurer.

In a significant departure from conventional reinsurance business processes, an embodiment of the system and method of the present invention manage reinsurance transactions by exception. In particular, the system and method run the reinsurance business based on a series of business rules for validation and based on contractual terms of the reinsurance agreement.

According to one embodiment, the present invention uses discrete modular business processes to execute reinsurance transactions. These modular business processes are by their nature re-configurable, such that they can be arranged in various sequences to execute a variety of reinsurance transactions. The modular business processes are the lowest logical units of work in a reinsurance transaction. These lowest logical units of work are sometimes referred to as business process definitions, business process designs, or business dynamics models. In one implementation of this embodiment, the logical units of work are defined by software programs (e.g., object-oriented software programs), which are arranged by a systems analyst/architect through a graphical user interface to create desired transactional tools.

The modular business processes enable the efficient and convenient creation of software tools that manage reinsurance transactions and that are easily modifiable and customizable to suit the varying needs of particular reinsurance transactions and organizations. A related embodiment provides modular system components, such as software applications, software routines, or computer systems, that execute these modular business processes.

The modular business processes also enable a reinsurer to create financial and actuarial models of its operations, to modify aspects of the model, and to assess the effect of such modifications on the expected profitability or risk profiles of the reinsurer. For example, a reinsurer can change the sequence of certain modular business processes that define a transaction, or can change the business rules that make up a modular business process, and then can examine the effect of these changes on such factors as expected cost or risk. By experimenting within a model office, the reinsurer can optimize operations to reduce costs, to improve the quality of data, and to reduce the risk of poor decisions.

In addition to supporting treaty generation, as outlined above, another embodiment of the present invention enforces treaty expiration, which is very important in allowing for the automatic processing of claims.

Another embodiment of the present invention supports back office functions, such as the receipt of claims, the processing of payments, and the maintenance of client accounts.

Another embodiment of the present invention facilitates automated ownership and fast track transactions.

Another embodiment of the present invention provides a versatile transactional framework that facilitates reinsurance dealings. According to this embodiment, the administrator of the system of the present invention can engage customers conveniently through thin clients, such as ordinary web browsers. This embodiment makes use of the feature described earlier that translates messages received from various clients, which tend to each be differently formatted.

As a significant benefit, the present invention enables a reinsurer to manage reinsurance transactions by exception, rather than handling each case individually. In other words, the present invention distinguishes transactions requiring special processing. For example, in the context of claims processing, the present invention validates and filters out claims not requiring special processing, and forwards only the exceptional claims for specific managerial action.

In addition to the advantages described earlier, the present invention provides the benefits of: 1) minimizing manual intervention in a reinsurer's business processes; 2) improving the quality and depth of information; 3) allowing the adoption of the new processes and components in a reinsurer's various regions to accommodate local market differences; 4) promoting collaboration across a reinsurer's business units to exploit cross-regional and global business expertise, as well as information technology expertise; 5) enabling more timely recognition of, and adaptation to, market and environmental changes; 6) enabling a reinsurer to make timely and factual business decisions based upon clean, accurate, consistent and timely information; and 7) enabling a reinsurer to reduce and maintain a low expense ratio.

### BRIEF DESCRIPTION OF THE DRAWINGS

The present invention will be explained in more detail, by way of example, with reference to the drawings.

FIG. 1 is a schematic diagram of client centric servicing, according to an embodiment of the present invention.

FIG. 2 is a schematic diagram of client centric servicing showing four exemplary service delivery channels through which to deliver services to clients, according to an embodiment of the present invention.

FIG. 3 is a schematic diagram of an exemplary system architecture, according to an embodiment of the present invention.

FIG. 4 is a schematic diagram showing the transaction system with data stores and functional modules, according to an embodiment of the present invention.

FIG. 5 is a schematic diagram of another exemplary system architecture according to another embodiment of the present invention.

FIG. 6 is a schematic diagram showing the information exchanged between the different business functions depicted in FIG. 5, according to an embodiment of the present invention.

### DETAILED DESCRIPTION OF THE INVENTION

An embodiment of the present invention, collectively referred to herein as transaction system” or “transaction method,” provides a system and method for transacting services between a service provider and a client by managing reinsurance transactions, including quote/treaty management, individual risk underwriting, reinsurance administration, claim administration, and financial management.

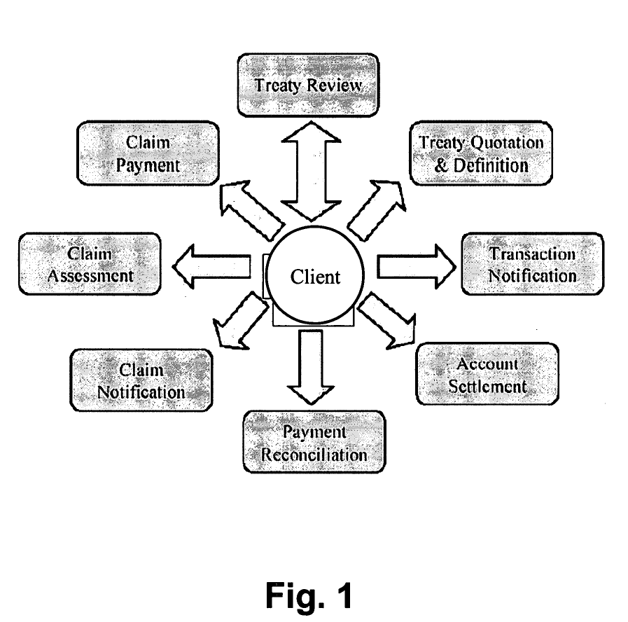

In one embodiment, the present invention supports these functions within the context of a reinsurer providing client-centric servicing. In client-centric servicing, all processes are designed and driven from events initiated by clients of the reinsurer,. delivering results that are valued by the clients. FIG. 1 illustrates one example of client-centric servicing, showing how management, administration, and claims processes interface with clients. The processes shown in FIG. 1 represent the distilled processes essential for the operational management of reinsurance. Generally, these processes are relevant and necessary no matter what implementation or channel (e.g., paper or electronic data exchange) is used to deliver reinsurance services to clients.

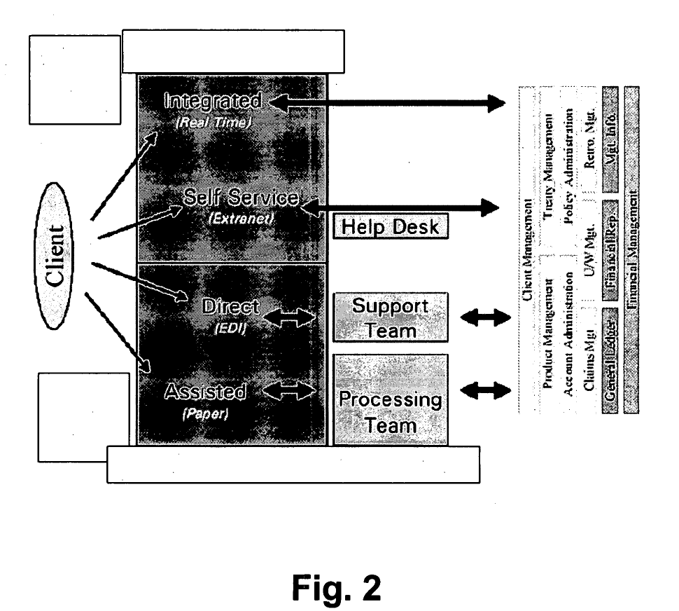

To support the client-triggered processes shown in FIG. 1, an embodiment of the present invention establishes four service delivery channels in which to deliver services to clients: assisted reinsurance, direct reinsurance, self service reinsurance, and integrated reinsurance. FIG. 2 highlights these channels along the left side as entry points into the reinsurer's processing and transaction environment.

Two technologies support the assisted reinsurance channel: an intranet portal and a paper portal. Data capture through the intranet portal involves manual support provided by a reinsurer processing team. Some automation is achievable, but typically manual intervention is involved. The paper portal provides a means to automate the capture and processing of data provided in the form of hardcopy paper or print files from those clients that are unable to provide data electronically through one of the other channels. This exemplary paper portal automates the extraction of data from claim notification forms and recurring payment listings to, among other things, eliminate the need for manual entry, to accelerate the response to the claims process, and to remove the risk of typing errors. The paper portal also captures incoming correspondence in electronic form.

In the direct reinsurance channel, the reinsurer provides a client interface based around electronic data exchange, requiring less manual support by the reinsurer. Some degree of direct access to policy, claims, and accounting information can be provided for the client, though the reinsurer typically actively manages much of this. Administration and claims are automated such that, under some circumstances, there is no human intervention in the process at all.

In the self-service reinsurance channel, the client drives the processes through electronic messaging and direct extranet interfaces. Business rules are applied on a real-time basis in a conversational dialogue. This dialogue ensures better quality data, and immediate feedback as to what the reinsurer will accept, except those items requiring special assessment. The majority of administration and claims is automated, and the service offers information about the progress of items that were not immediately approved, also via the direct extranet interface. Clients are responsible for reconciling policy, claim, and accounting data as provided to the reinsurer.

The integrated reinsurance channel is an extension of the direct and self-service channels, upgrading the operation of the processes to real-time interfaces with clients. In essence, clients drive the reinsurance process directly from their own systems. Business rules are applied real-time. The reinsurer is primarily concerned with performing analyses of the business, optimization of the business rules and controls, and innovating new opportunities.

Within the context of the client-centric servicing shown in FIGS. 1 and 2, an embodiment of the present invention provides a system and method for supporting quote/treaty management, reinsurance administration, risk underwriting, claim administration, and financial/risk management.

Quote/Treaty Management:

Quote or treaty management involves the management of the rules of engagement between the client and reinsurer for assumed and retrocession treaties, and resolves into four main sub-processes: quotation, definition, review, and termination. Treaty quotation encompasses the processes from the receipt of a tender from a client through the compilation and dispatch by the reinsurer of quotes in relation to the tender and onto the ultimate acceptance or rejection of the quote by the client.

Treaty definition encompasses the processes of setting up a treaty, business rules, and an account from the collection of information to produce the initial treaty agreement in response to an accepted quote, through the processes of internal authorization and agreement, and onto the ultimate acceptance or rejection of the form of the treaty agreement by the client.

Treaty review encompasses all processes involved with the assessment of treaty performance and profitability as assessed against measures defined during treaty definition. It involves the production of analyses of and reports concerning treaty performance and the decision based on those analyses and reports to continue, modify, or terminate the treaty.

Treaty termination occurs when treaty review results in a decision to terminate the treaty for new business or otherwise, or when the client wishes to negotiate such a termination. It encompasses all processes from the compilation of termination terms, through the negotiation of those terms with the client, and onto the termination or other modification of the terms of the treaty.

Reinsurance Administration:

Reinsurance administration deals with all activity relating to the maintenance of the reinsurer's policy information and the processing and reconciliation of the reinsurer's accounts. This resolves into five main processes: transaction notification, account receipt and reconciliation, payment receipt and reconciliation, retrocessional transaction notification and outward payment production. This embodiment of the present invention supports back office functions, such as the receipt of claims, the processing of payments and the maintenance of customer accounts.

As one of the five main processes, transaction notification is the process by which the reinsurer receives and acts on transaction information from ceding companies. Transaction notifications are received in batches on a periodic basis, and may also be notified in real time on an individual basis. Each transaction notification details some element of policy information (either a new policy or a change to an existing one) or claim information.

Account receipt and reconciliation is the process by which the reinsurer receives from its clients account settlement figures. Each settlement relates to the aggregation under the terms of the subject treaty of a number of transaction notifications. Settlement figures are reconciled against the transactions to which they relate.

Payment receipt and reconciliation are the processes by which the reinsurer handles the receipt and banking of payments items, and the reconciliation of these payments with the settlements, sent by the client, to which they relate.

Processes relating to retrocessional coverage ensure that appropriate notifications are delivered to the reinsurer's retrocessionaires. The process accumulates, for one period, all transactions received from ceding companies relating to the same retrocessionaires and delivers one retrocessional transaction notification to cover all such subject transactions.

Outward payment production processes are the processes related to outward payments by the reinsurer for retrocessions and claims. The processes first authorize payment and then determine the correct payment method (e.g., check or electronic funds transfer), before generating and sending the payment.

Risk Underwriting:

Facultative underwriting deals with all activity relating to the assessment and acceptance/rejection of individually proposed insurance risks falling outside the automatic acceptance terms of a given treaty. The principal business processes concern the assessment of facultative cases where the proposal exceeds the monetary limit as stipulated in the treaty as the automatic acceptance authority, and the underwriting limit of the treaty, which stipulates the extent of the risk that the client can accept before resorting to the reinsurer for acceptance.

Claim Administration:

Claim administration is the high-level business process incorporating all of the processes necessary to administer the entire lifecycle of an individual claim or group of claims. It resolves into two main sub-processes: notification and management.

Claim notification is the process by which the reinsurer is informed of a potential claim or a request for advice on a claim from a client. The details of the claim can come via one of three channels depending on the client's preferred method: electronic transmission, an Internet web page, or by account. At the time of notification, the client may also send in a payment request. Claim notification captures all of the claim details to ensure there is sufficient information to process and validate the claim. It uses the treaty details recorded during the treaty management process to identify if the claim is in-force and to check the claim limits. Claim notification then rejects or refers claims to a technical claims department for a detailed assessment, and monitors and records the number of invalid claim requests from clients so that action can be taken to improve the quality of the data that the reinsurer receives.

Claim management ensures that claims are assessed (where appropriate), reviewed, paid, and closed in a timely manner. The claim management process communicates the outcome of a claims request and progress to the client. The client is able to monitor the progress of a claim through the notification, assessment, and acceptance processes. In addition, this embodiment of the present invention supports treaty generation for claim management.

Financial/Risk Management:

Financial management represents the core executive process of monitoring, reporting, and managing the profitability and risk exposure of the reinsurer. This resolves into three main subprocesses: reporting, valuation, and management information.

Financial reporting is the process by which information is collated and reported to recipients to the reinsurer, to the reinsurer's clients, and to regulatory bodies. The present invention makes report collation and distribution automatic, with the data recorded accurately and to the right level of detail.

Valuation is the process that involves the compilation of a reinsurer's typically largest liability, namely, reserves. The process is complex and requires a significant amount of data and assumptions from various resources. The objective is to allow for effective and efficient accessing and aggregating the required data and assumptions in a standardized format.

The management information process involves the compilation and distribution of relevant business details across core business areas. In one embodiment, this process is supported through an online tool that allows swift manipulation of data to aid investigation and forecasting. The management information process is similar to financial reporting in that the dynamic process of collating and reporting on data is the same across both processes. One difference, however, is in the emphasis, in that financial reporting is more concerned with the production of pre-defined reports for a specific purpose, while the management information process is more ad-hoc.

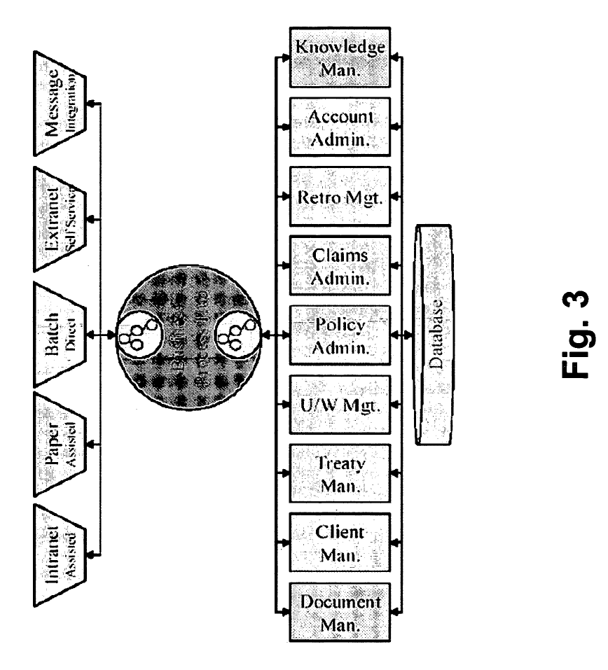

FIG. 3 illustrates an exemplary system architecture upon which the above-described processes are implemented. The overall architecture is based on direct support for the four key service delivery channels described above. The architecture includes three layers: context translation, business process control, and business service components.

The context translation layer acts as the reinsurer's interface with its clients. An objective of this layer is the translation of the relevant data from the client's context (i.e., structure and codes) to the reinsurer's and vice versa. The context of the reinsurer can be represented as, for example, standard XML messages that form a library of known business notifications that the reinsurer's back office applications can process.

The business process control layer receives messages (for example, XML messages) from the context translation layer. Upon receipt of a recognized message, the business process control layer identifies and initiates the corresponding business workflow. The individual steps within the workflow represent recognizable and distinct business services.

The business service components layer initiates stateless business services through the provision of an appropriate service message (for example, XML message) to one of a number of business components. These components implement the relevant service and notify the process hub (see FIG. 3) on successful completion, including, where necessary, an updated XML message.

A context translation layer supports each of the above-described required service delivery channels. For the assisted delivery channel, the manual translation of data provided by the reinsurer's clients in non or inappropriate electronic formats by internal resources is supported through two main technology approaches. The first approach involves an intranet capability, for example, JSP supported HTML pages provided by an IBM Websphere™. The second approach involves an optical character recognition (OCR) scanning capability, such as a Kofax™ supported scanning of documents with OCR extraction of text for the appropriate document types.

For the direct delivery channel, batch data (e.g., EDI or batch XML files) from the reinsurer's clients is electronically translated, using, for example, Data Junction™ and Sonic B2B™ technology.

For the self-service delivery channel, the direct entry of data by the reinsurer's clients is supported by an extranet capability using the same technologies as the Intranet. This approach also supports direct two-way communication with the clients including the provision of data and their involvement with the business workflow.

The integrated delivery channel involves the real-time exchange of data between the reinsurer's clients and its applications, using, for example, XML posts across the Internet. This approach can be supported using, for example, a Sonic B2B™ integration server, but in this example handles individual transaction notifications.

The XML messages published by these four channels are passed to the business process hub shown in FIG. 3, which recognizes two basic message forms: atomic and enterprise messages. The atomic form use XML notifications that generally represent an immediate request and, as such, contain only a single business step, such as to retrieve a particular claim. There is no real process to control in this situation. Therefore, the request is passed synchronously to the appropriate business service.

The enterprise message form includes XML notifications that represent a true multi-step business process, such as a claim notification or policy amendment. The process control for these is supported by, for example, a Sonic B2B™ integration server, which is requested asynchronously using MQSeries™. This therefore releases the channel providing a simple acknowledgement. The B2B integration server recognizes the message and initiates the required business workflow.

The exemplary approach shown in FIG. 3 supports, using branches or sub-processes within the workflow, the ability to recognize regional differences within the reinsurer's global business processes. The individual steps within the business process represent remote calls to the services provided by the appropriate business components. There are three key types of the business component: new business, legacy-based, and package-based. The new business services are, for example, Enterprise Java Beans™ within IBM Websphere™ connected to an Oracle DBMS™.

Legacy-based business services are delivered through any existing legacy system that may exist, such as CORBA supported through lona's Orbixweb™, ADABAS Natural™, and Informix 4GL™.

Package-based business services are delivered to package applications, a key one of which is the document management function, as shown in FIG. 3.

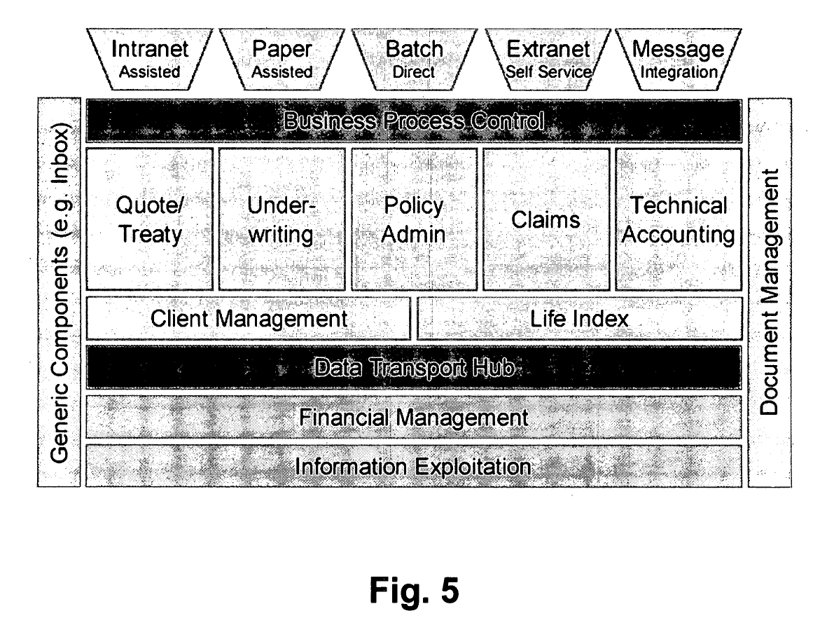

FIG. 5 illustrates an exemplary system architecture according to another embodiment of the present invention.

As shown in FIG. 5, the architecture includes generic components and document management functions spanning multiple layers. Generic components include, for example, an inbox application, which provides focused analyses based on exceptions, controlled workflows, mandatory resolution of errors, and operational data. The document management functions provide document versioning, on-line help, procedure manuals, a glossary, electronic document storage, and electronic document attachment.

As with the architecture of FIG. 1, the embodiment of FIG. 5 establishes four service delivery channels in which to deliver services to clients: assisted reinsurance (intranet and paper), direct reinsurance (batch, e.g., on tape media), self service reinsurance (extranet), and integrated reinsurance (message).

In FIG. 5, client management provides global client management, for example, for use in disbursements. For example, client management specifies settlement instructions for a client, such as allowing the client to settle only with a particular bank.

User management manages user information and access, requiring, for example, mandatory user profile set-up (e.g., authorizations). The user management application is a security model through which the reinsurer can define who can do what, where, when, and how, and what the escalation cost is. For example, the user management application can require that only an authorized representative, such as a CEO or pricing officer sign a treaty.

The service channels ensure that the information received from clients is translated into a standard format. This standardized data is then delivered to the business process control layer.

As shown in FIG. 5, the quote/treaty function provides standardized data capture, mandatory functional experts input, mandatory data capture, and automatic generation of treaties. Upon issuing a quote, the quote function manages the expiration of the quote, which allows the reinsurer to manage exposure to unintended risk. Upon quote acceptance, the quote/treaty function also notifies/engages downstream processes, thereby providing valuable internal control for the reinsurer. The treaty function enforces treaty expiration—an important feature in allowing for the automatic processing of claims.

The mandatory data capture function displays error messages if a user attempts to proceed to the next screen without filling in the mandatory fields. The screens capture data elements and attachments. The attachments are especially convenient because they contain the information important for the quote, such as conversion rate, reinsurance rate, retrospective premium information, and treaty limits.

The mandatory functional experts input function is a quality assurance check that requires a user to obtain input where required from experts such as administrative experts, claims experts, and underwriting experts. This feature prevents, for example, a user who is primarily responsible for pricing treaties from entering treaty requirements that fail to account for factors involved in administering the business. An exemplary graphical user interface (GUI) implementing this feature provides time stamps that require responses within a certain time.

In requiring the input of mandatory data at an early stage of the quote process, the quote/treaty function facilitates the timely generation of an accurate treaty. The reinsurer can then quickly offer the treaty to the client. In one embodiment, the reinsurer communicates the offer to the client through a secured extranet. The offer could be posted on a “tender information” tab, which would contain general pricing, underwriting claims, administration, reinsurance offer information, and reinsurance assumption information.

In a further aspect of the present invention, the data captured through the quote/treaty function is used to define business rules between the reinsurer and the particular client. These service-specific rules define the parameters against which data received from the client is judged. For example, the captured data may include coverage terms, which are then transformed into business rules that define what claims will be paid. The reinsurer compares the claims data received from the client against these rules to determine if claims should be paid.

According to the facultative underwriting function, every underwriting case is linked to a client and treaty. In addition, the facultative underwriting function provides an identification of how many underwriting cases are placed (placement rates when client provides the data). The facultative underwriting function also provides integrated retention management, which yields an index of the total exposure associated with a client. The facultative underwriting function also provides key workflow reports, which help underwriters to issue quotes as quickly as possible and win business.

Within the context of facultative underwriting, one aspect of the present invention enables an underwriter to capture the annotations that are frequently added to underwriting documents. These notes can be recorded electronically in a notes manager, which can be referred back to later during other phases of the reinsurance process (such as claims). This note manager can also be used in these other phases of the reinsurance process to capture annotations. In the claims process, for example, when it is necessary to consult the treaty terms, the annotations can be helpful in explaining the terms.

Within the architecture of FIG. 5, the present invention provides message management, which includes automated data mapping (treaty driven), proactive reporting (such as client reporting or error reporting), the creation of data acquisition team/analysts, operational data capture (dashboard/knowledge management), and automated treaty compliance.

Message management enables the reinsurer to receive data from clients in various formats, standardize the data (for example, into a universal data format of the reinsurer), and distribute the data throughout the system. This embodiment therefore provides a versatile transactional framework that facilitates reinsurance dealings. The administrator of the system of the present invention can engage customers conveniently through thin clients, such as ordinary web browsers. This embodiment translates messages received from various clients, which tend to each be differently formatted.

With respect to automated treaty compliance, the present invention enables a reinsurer to receive transactions (e.g., concerning premiums, claims, commissions, terminations, and loss events) from a client and determine whether the transactions are associated with the client's policies. If not, then the reinsurer can withhold payment. The present invention also monitors the clients' compliance with “rules of engagement,” which set out the conditions of the relationship between the reinsurer and client. One example of a rule is that the client must submit a report to the reinsurer by the 15^{th} of every month.

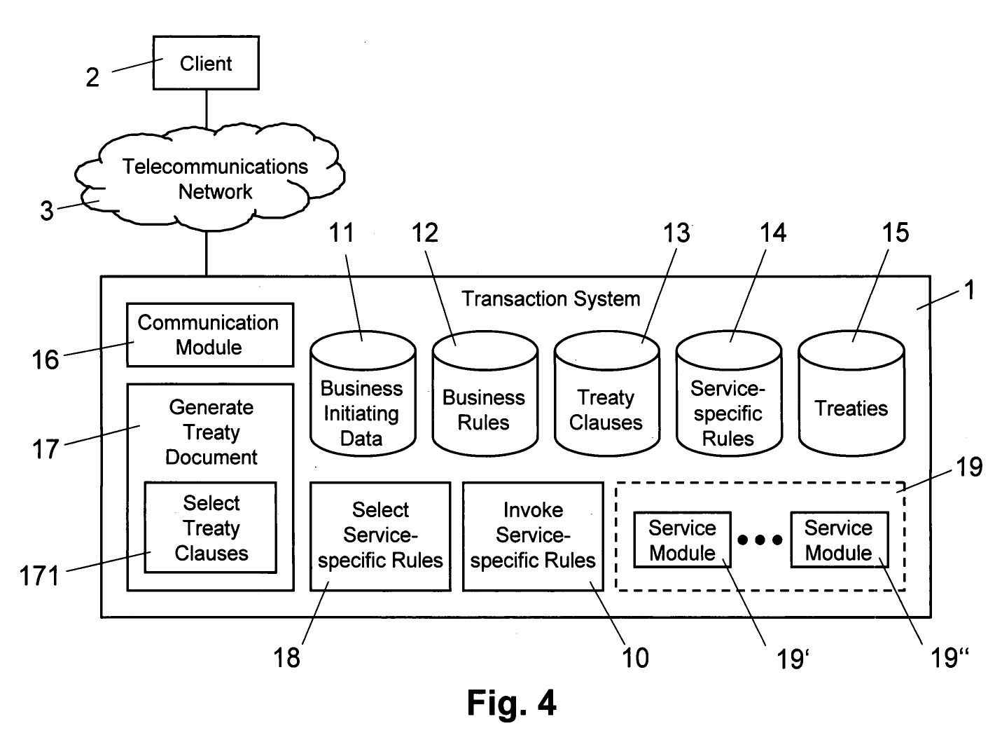

In FIG. 4, reference numeral 1 refers to a computer-based transaction system 1 for executing a transaction method for transacting services between the service provider (e.g., the reinsurer) and the client (e.g., the cedent), according to an embodiment of the present invention. The transaction system 1 may include one or more computers each comprising one or more processors. As is illustrated in FIG. 4, the transaction system 1 is connected via a telecommunications network 3 to at least one client 2. The electronic service delivery channels described above (direct reinsurance channel, self-service reinsurance channel, and integrated reinsurance channel) are implemented through telecommunications network 3. The telecommunications network 3 can include a fixed network such as the Internet, a VPN (Virtual Private Network), a LAN (Local Area Network), or a WAN (Wide Area Network). In an embodiment, the telecommunications network 3 includes a mobile radio network such as a GSM (Global System for Mobile Communications) or UMTS (Universal Mobile Telecommunication System) network or a WLAN (Wireless LAN). The client 2 is connected to the telecommunications network 3 via a computerized terminal, for example a personal computer. The transaction system 1 includes a communication module 16 for electronic message exchange with the client 2 via the telecommunications network 3.

The transaction system 1 includes a data store 11 for storing business-initiating data received via the telecommunications network 3 from a client; a data store 12 for storing business rules, particularly business rules for defining a treaty and for defining data requirements; a data store 13 for storing treaty clauses; and a data store 14 for storing service specific (business) rules. The data stores may be implemented as a database on one or more computers, as structured files on one or more file servers, and/or as tables embedded in program code or memory, for example.

The business rules, including the service specific rules, comprise a rule identifier, a rule logic specifying conditions on data values, as well as rule actions associated with different conditions. It must be emphasized that the conditions may apply to data values of single data elements as well as to data values and interrelationships of multiple data elements. The business rules are applicable to data elements included in electronic messages received from the client 2 as well as to data elements stored in data stores (e.g., databases or memory) accessible by the transaction system 1. The data elements contain information provided by the client (e.g., service type, service parameters, and supported data format(s)), by the service provider, and/or by the transaction system 1 (e.g., process, transaction or document status information). The actions include, for example, requests for further information from the client or the service provider, enabling or disabling processing features of the transaction system 1, setting of defined boundaries for specific data elements, setting of defined status information, updating defined information in the data stores, selecting service-specific rules such as data requirements and format, and creating data objects such as treaties and treaty documents. The treaty clauses include a treaty clause identifier and a treaty text assigned to the treaty clause identifier.

As is illustrated schematically in FIG. 4, the transaction system 1 also includes several service modules 19. The service modules 19 are implemented on one common computer or on several separate but interconnected computers. The service modules 19 include programmed software modules configured to manage electronic messages and to manage reinsurance transactions, including quote/treaty management, individual risk underwriting, reinsurance administration, claim administration, and financial management.

Before data received from the client 2 is further processed, the transaction system 1 checks completeness of the data by applying the respective business rules to the data. If business-initiating data related to a tender is received from the client 2, the service module 19′ configured for quote/treaty management ensures that requirements on data to be provided by the client and by the service provider are fully met, before a quote is generated for the tender. For that purpose, the service module 19′ configured for quote/treaty management includes programmed functions for a quote driver to electronically request input of missing data from functional experts associated with the type of missing data (e.g., pricing actuary, sales manager, technical accountant, or claims manager.). Missing data from the client is requested automatically by the transaction system 1 from the client. Once all the data requirements are met by client and service provider, the service module 19′ configured for quote/treaty management generates automatically a quote and forwards the quote to the client 2. When an acceptance of the quote is received from the client 2, a treaty is generated automatically by the transaction system 1, as described below.

The transaction system 1 includes a module 17 comprising program code for generating automatically a treaty document. Module 17 includes programmed function 171 for selecting treaty clauses from data store 13 by applying the business rules from data store 12 to the business-initiating data received from the client 2. Module 17 composes a treaty document from the treaty clauses selected by programmed function 171. Treaties, including the treaty document generated by module 17 and a treaty identifier, are stored in data store 15. For compression purposes, the treaty document may be stored as a set of treaty clause identifiers associated with the treaty document. The treaties are assigned to the respective client 2 (client identifier).

Furthermore, the transaction system 1 includes program code 18 for selecting automatically from data store 14 selected service-specific rules related to treaty clauses forming a particular treaty document. The service-specific rules can be selected based on defined business rules. The selected service-specific rules related to treaty clauses are stored assigned to the respective treaty (treaty identifier) and/or client (client identifier). The program code 18 is configured to select and store different sets of selected service-specific rules for the different service modules 19. Each set of selected service-specific rules is assigned a service set identifier. Execution of program code 18 is triggered by module 17. In response to defined conditions and events, for example in response to a request from one of the service modules 19, the service-specific rules are invoked and applied by the transaction system 1 using program code 10. For invoking the service-specific rules, program code 10 is provided by the requestor with the respective treaty identifier, client identifier, and/or service set identifier. In an embodiment, invocation and automatic selection of the service-specific rules is triggered by defined conditions and events, such as a request from one of the service modules 19.

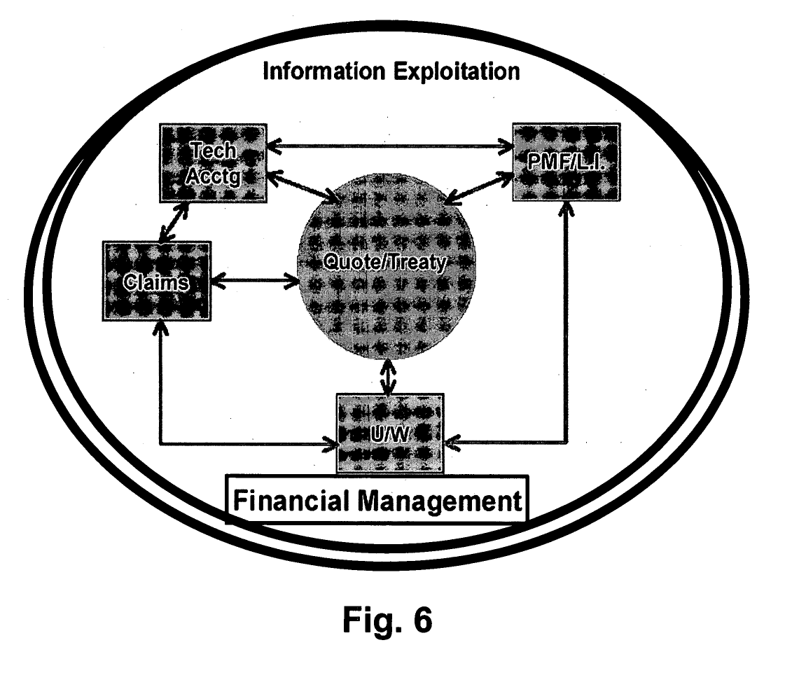

The functionality of module 17, programmed function 171, program code 10 and 18, and service module 19′ is associated with the quote/treaty function, described herein with reference to FIGS. 5 and 6.

The selected service-specific rules define, for example, the criteria and conditions under which data received from the client 2 is processed. Depending on the type of service module, the selected service-specific rules determine the processing of business-oriented transactions such as claims processing (e.g., coverage terms or treaty compliance) or the processing of purely technical transactions such as electronic message transfer. In the latter case, the selected service-specific rules related to treaty clauses define metadata for an electronic message transfer from the client to the service provider. The metadata determines the expected data structure, including syntax and semantics, of a particular type of electronic message received from the client. Specifically, the metadata defines which data elements are to be included in the electronic message and includes data to determine the position, length, and meaning of these data elements. Once a received electronic message is associated with a particular client and/or treaty, the service module 19″ configured for message management requests the metadata by triggering respective services of program code 10 and, if the metadata has not been previously selected and stored in the data store 14, program code 18. Subsequently, using the metadata, the service module 19″ configured for message management automatically maps the electronic message received from the client into a data format defined by the service provider. Mapping of received electronic messages into the service provider's data format is based on defined data presentation specifications associated with different message types and stored in the transaction system 1, for example ASN. 1 (Abstract Syntax Notation One) or another syntax notation.

The selected service-specific rules also include or define rules of engagement between the client and the service provider. Rules of engagement are algorithms triggered by defined events and conditions. For example, rules of engagement determine requirements on the electronic message transfer such as times and frequencies at which particular (types of) electronic messages are to be received from the client. The service module 19″ configured for message management is designed to monitor a client's compliance with the rules of engagement related to electronic messaging. When the client 2 does not meet rules of engagement, the transaction system 1 generates error and/or reminder messages, for example.

The life index of FIG. 5 provides the following features: consist/automated life index (e.g., local to global); automated life index matching (such as a name scrubber, which operates across different languages, phonetics, and spellings to associate different versions of a name to a single person); a policy master file (PMF) automated link to quote treaty pricing segment (how business is priced); consistency of data mandatory minimum data (PMF); skeleton versus non-skeleton data; retention management (e.g., underwriting and retrocession); and policy exhibit projects hypothetical in force.

The technical accounting of FIG. 5 provides the following features: reduced manual input; automated cash allocation; accrual exception reporting; automated payment authorization; automated delinquency checks (reporting and cash); availability of timely treaty information; automated settlement instructions; automated links to client data; determination of settlement method; and mandatory documentation of overrides.

In exemplary GUIs of the operational data associated with technical accounting, automated settlement instructions as dictated by the treaty are entered into the system, which preferably cannot be changed by anyone in administration (except those with appropriate authority).

Mandatory documentation of overrides records who overrides business rules. For example, the system will not allow a check to be cut to a client if that client is delinquent. However, a user with appropriate authority can override this rule and cut the check. In so doing, this feature of the system documents the identity of the manager overriding the business rule.

The claims function of FIG. 5 provides automated ownership (i.e., fast track transactions), shift administration, shift to exception handling, focused assessment (i.e., referral rules), identification of key data (e.g., major events), fully integrated systems/processes, and key statistics (e.g., operational).

As shown, the architecture of FIG. 5 enables a reinsurer to exploit information. This information exploitation can include, for example, a reduction of reconciliation from source systems, data standardization, operational data reporting, and the creating of a single source of data (e.g., data warehouse).

To further illustrate the present invention's ability to exploit information, FIG. 6 shows the information exchanged between the different business functions (which could be, for example, business units of the reinsurer) depicted in FIG. 5. The quote/treaty function is centered in the FIG. 6 to represent the typical start of the reinsurance business. In this phase, the reinsurer is soliciting business by quoting treaties. As the start of the process, the quote/treaty function interacts with all other components of FIG. 6.

Turning to the other interactions shown in FIG. 6, the policy master file/life index (PMF/LI) function interacts with quote/treaty, technical accounting, and underwriting. Technical accounting interacts with quote/treaty, claims, and PMF/LI. The claims component interacts with quote/treaty, technical accounting, and underwriting. Underwriting interacts with quote/treaty, PMF/LI, and claims. These various interactions enable information exploitation and financial management.

The value of this information exploitation is apparent when one considers the conventional methods of managing reinsurance, which historically have been based on financial reporting requirements. Traditionally, reinsurers have written treaties and recorded those treaties in a treaty ledger, which is basically an accounting tool. This tool drives the accounting results, for example, ensuring that the information entered into the treaty ledger ultimately produces the cash and reserve balances and all other reporting information required for the production of required financial statements. Unfortunately, this accounting-driven approach fails to fully reflect the richness of the underlying reinsurance business or risk. What should be driving the reinsurance business is the risk information, such as treaty performance information and the statistical accumulation of experiences on a treaty specific basis, a risk specific basis, a geographical distribution basis, and a domestic basis. Addressing this need, an embodiment of the present invention builds data warehouses containing valuable information concerning the risk attributes of the business reinsured. In exploiting the information, the present invention provides workflows driven by risk standards, rather than by financial reporting.

With reference to FIGS. 5 and 6, an important aspect of the present invention is its ability to manage by exception. In other words, the business process managers responsible for the different reinsurance functions (e.g., claims and underwriting) do not need to handle each and every case submitted to the system. Rather, these managers need only address the specific exceptions within the process that require more analysis. Thus, for example, the system filters cases so that a claims manager sees only the difficult or unusual cases that require the claim manager's expertise. In this way, the filter automatically settles claims meeting certain business rules and forwards the noncompliant cases to the claims manager for further analysis. In one embodiment, the generic components or inbox of FIG. 5 serves this “management by exception” function.

Also with reference to FIGS. 5 and 6, an important aspect of the present invention uses discrete modular business processes to execute reinsurance transactions. These modular business processes are by their nature re-configurable and re-usable, such that they can be arranged in various sequences to execute a variety of reinsurance transactions. The modular business processes are the lowest logical units of work in a reinsurance transaction. In one implementation of this embodiment, the logical units of work are defined by software programs (e.g., object-oriented software programs), which can be arranged by a systems analyst/architect through a graphical user interface to create desired transactional tools.

In an embodiment of the present invention, these modular business processes are used to define the overall business process of reinsurance administration.

The modular business processes also enable a reinsurer to create financial and actuarial models of its operations, to modify aspects of the model, and to assess the effect of such modifications on the expected profitability or risk profiles of the reinsurer. For example, a reinsurer can change the sequence of certain modular business processes that define a transaction, or can change the business rules that make up a modular business process, and then can examine the effect of these changes on such factors as expected cost or risk. By experimenting within a model office, the reinsurer can optimize operations to reduce costs, to improve the quality of data, and to reduce the risk of poor decisions.

A significant benefit of the modular business processes is their ability to be assembled in various sequences to accomplish different functions. In this manner, the present invention can be customized to accommodate the operations of various reinsurers.

Although described as an embodiment of the present invention within the context of life and health insurance and reinsurance, one of ordinary skill in the art would appreciate that the present invention is not limited to this particular context. Indeed, the systems and methods of the present invention are broadly applicable to other types of insurance businesses, such as property and casualty, as well as to other businesses in general, such as financial services.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM, etc.) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code) to be ready to be executed by a processor.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A computer-based transaction system operated by a service provider, the system comprising:
a stored set of business rules for defining a treaty;
a stored set of treaty clauses;
a stored set of service-specific rules;
a communication module that receives business-initiating data via a telecommunications network from a client;
a treaty module that generates a treaty document by applying the business rules to the business-initiating data to select treaty clauses forming the treaty document;
a rule selection module that selects automatically from the service-specific rules selected service-specific rules related to the treaty clauses forming the treaty document; and
at least one service module configured to transact services between the service provider and the client using the selected service-specific rules.

2. The system of claim 1, the service-specific rules defining metadata for an electronic message transfer from the client to the service provider, and the at least one service module being configured to process electronic messages received from the client using the metadata defined by the selected service-specific rules.

3. The system of claim 1, the at least one service module being configured to map automatically electronic messages received from the client into a data format defined by the service provider and based on metadata defined by the selected service-specific rules.

4. The system of claim 1, the service-specific rules including rules of engagement between the client and the service provider, and the at least one service module being configured to check that electronic messages are received from the client at times and frequencies defined by the rules of engagement included in the selected service-specific rules.

5. The system of claim 1, the system including different service modules configured to transact different services between the service provider and the client, the rule selection module being configured to select different sets of selected service-specific rules for the different service modules, and the system further comprising an invocation module that applies the different sets of selected service-specific rules to the respective service modules.

6. The system of claim 1, the rule selection module being configured to store the selected service-specific rules assigned to at least one of the treaty document and the client, and the at least one service module being configured to transact services between the service provider and the client using the selected service-specific rules assigned to the at least one of the treaty document and the client.

7. The system of claim 1, the rule selection module being configured to store the selected service-specific rules assigned to at least one of the treaty document and the client, the at least one service module being configured to associate an electronic message received from the client with the at least one of the treaty document and the client, and the at least one service module being configured to process the electronic message using the selected service-specific rules assigned to the at least one of the treaty document and the client associated with the electronic message.

8. The system of claim 1, the treaty document including performance measures, and the system further comprising means for determining performance and profitability of services governed by the treaty document by assessing service-specific data related to the services governed by the treaty document against the performance measures.

9. The system of claim 1, the business-initiating data relating to a tender from the client to the service provider for reinsurance, and the system further comprising:
a stored set of business rules defining data requirements;
means for checking completeness of the business-initiating data based on the data requirements, before generating automatically a quote for the tender;
means for receiving from the client an acceptance of the quote, the treaty module being configured to generate the treaty document in response to the acceptance of the quote, and the treaty document including contractual clauses of a reinsurance agreement; and
means for receiving from the client an acceptance of the treaty document, the rule selection module being configured to select the service-specific rules in response to the acceptance of the treaty document, and the services transacted by the at least one service module between the service provider and the client including reinsurance services.

10. A computer-implemented method for transacting services between a service provider and a client, the method comprising:
storing in a computer system a set of business rules for defining a treaty;
storing in the computer system a set of treaty clauses;
storing in the computer system a set of service-specific rules;
receiving in the computer system business-initiating data from the client via a telecommunications network;
generating by the computer system a treaty document by applying the business rules to the business-initiating data to select treaty clauses forming the treaty document;
selecting automatically by the computer system from the service-specific rules selected service-specific rules related to the treaty clauses forming the treaty document; and
transacting by the computer system the services between the service provider and the client using the selected service-specific rules.

11. The method of claim 10, the transacting of the services between the service provider and the client including processing electronic messages received from the client using metadata defined by the selected service-specific rules.

12. The method of claim 10, the transacting of the services between the service provider and the client including automatically mapping electronic messages received from the client into a data format defined by the service provider and based on metadata defined by the selected service-specific rules.

13. The method of claim 10, further comprising checking by the computer system that electronic messages are received from the client at times and frequencies defined by rules of engagement defined by the selected service-specific rules.

14. The method of claim 10, further comprising:
storing by the computer system the selected service-specific rules assigned to at least one of the treaty document and the client; and
associating an electronic message received from the client with the at least one of the treaty document and the client,
the transacting of the services between the service provider and the client including processing the electronic message using the selected service-specific rules assigned to the at least one of the treaty document and the client associated with the electronic message.

15. A computer program product comprising computer program code controlling one or more processors of a computer system operated by a service provider, such that the computer system:
stores a set of business rules for defining a treaty;
stores a set of treaty clauses;
stores a set of service-specific rules;
receives business-initiating data from a client via a telecommunications network;
generates a treaty document by applying the business rules to the business-initiating data to select treaty clauses forming the treaty document;
selects automatically from the service-specific rules selected service-specific rules related to the treaty clauses forming the treaty document; and
transacts services between the service provider and the client using the selected service-specific rules.

16. The computer program product of claim 15, the computer system processing electronic messages received from the client using metadata defined by the selected service-specific rules.

17. The computer program product of claim 15, the computer system mapping automatically electronic messages received from the client into a data format defined by the service provider and based on metadata defined by the selected service-specific rules.

18. The computer program product of claim 15, the computer system checking that electronic messages are received from the client at times and frequencies defined by rules of engagement defined by the selected service-specific rules.

19. The computer program product of claim 15, the computer system storing the selected service-specific rules assigned to at least one of the treaty document and the client, associating an electronic message received from the client with the at least one of the treaty document and the client, and processing the electronic message using the selected service-specific rules assigned to the at least one of the treaty document and the client associated with the electronic message.

20. A method for transacting services between a service provider and a client, the method comprising:
receiving business-initiating data from a client via a computer network;
applying treaty-defining business rules to the business-initiating data to select applicable treaty clauses;
determining service-specific rules related to the applicable treaty clauses;
selecting from the service-specific rules selected service-specific rules related to the applicable treaty clauses; and
transacting, using a computer, services between the service provider and the client according to the selected service-specific rules.

21. The method of claim 20, further comprising assembling the applicable treaty clauses into a treaty document between the service provider and the client.

22. The method of claim 20, the transacting of the services including processing electronic messages received from the client using metadata defined by the selected service-specific rules.

23. The method of claim 20, the transacting of the services including automatically mapping electronic messages received from the client into a data format defined by the service provider and based on the metadata defined by the selected service-specific rules.

24. The method of claim 20, further comprising checking that electronic messages are received from the client at times and frequencies defined by rules of engagement defined by the selected service-specific rules.

25. The method of claim 20, further comprising:
associating rules of the selected service-specific rules with a treaty;
receiving an electronic message associated with the treaty; and
processing the electronic message using the selected service-specific rules associated with the treaty.

26. The method of claim 20, the business-initiating data relating to a tender from the client to the service provider for reinsurance.

27. The method of claim 26, the method further comprising:
storing a set of business rules defining data requirements;
checking completeness of the business-initiating data based on the data requirements, before generating automatically a quote for the tender;
receiving from the client an acceptance of the quote;
assembling the treaty clauses into a treaty document in response to the acceptance of the quote, the treaty document including contractual clauses of a reinsurance agreement;
receiving from the client an acceptance of the treaty document; and
selecting the selected service-specific rules in response to the acceptance of the treaty document,
the services transacted by the at least one service module between the service provider and the client including reinsurance services.
